(19) United States
(12) Patent Application Publication
(10) Pub. No.: US 2025/0048132 A1
(43) Pub. Date: Feb. 6, 2025

(54) 5G AND WIFI SYSTEM

(71) Applicant: DISH Wireless L.L.C., Littleton, CO (US)

(72) Inventor: In-Kyung KIM, Highlands Ranch, CO (US)

(73) Assignee: DISH Wireless L.L.C., Littleton, CO (US)

(21) Appl. No.: 18/364,047

(22) Filed: Aug. 2, 2023

(51) Int. Cl. H04W 24/02; H04W 16/14; H04W 16/18; H04W 24/10; H04W 64/00

(52) U.S. Cl. CPC H04W 24/02; H04W 16/14; H04W 16/18; H04W 24/10; H04W 64/00

(57) ABSTRACT

In order to operate and maintain a wireless network system in a building that includes a 5G network and a Wi-Fi network, the master node captures location data and measurement data reported by one or more mobile devices. The master node then uses the location data and the measurement data reported by the one or more mobile devices and measurement data captured by the master node to optimize network performance, and adjusts one or more parameters within the wireless network system.

### FIELD

The present invention generally relates to the operation and maintenance of a wireless network system configured to operate on both 5G and Wi-Fi networks.

### BACKGROUND

The wireless (e.g., 5G or Wi-Fi) deployment, especially involving multiple access points (APs), most of the time is not optimized and does not provide a mechanism of optimizing the network after installation. This is because the initial installation is mostly ad-hoc, i.e., going through some trials and errors. This process yields a non-optimal state, and also, the configuration stays forever. Even in a case where the perdition or simulation tool is used, which can avoid the tedious trial and error effort, the assumptions are estimates, which are not replicative of the actual numbers. Hence, the installation will not be optimal. Also, after the installation, the operation environment can change, e.g., user equipment (UE) distributions and density, traffic patterns, configurations of the venue, etc., all of which can further degrade the performance over the time.

Accordingly, an improved and/or alternative approach may be beneficial.

### SUMMARY

Certain embodiments of the present invention may provide solutions to the problems and needs in the art that have not yet been fully identified, appreciated, or solved by current communication technologies, and/or provide a useful alternative thereto. For example, some embodiments of the present invention pertain to the operation and maintenance of a wireless network system configured to operate on both 5G and Wi-Fi networks.

In an embodiment, a computer-implemented method for operating and maintaining a wireless network system comprising a 5G network and a Wi-Fi network includes capturing, by a master node, location data and measurement data reported by one or more mobile devices. The method also includes using, by the master node, the location data and the measurement data reported by the one or more mobile devices and measurement data captured by the master node to optimize network performance, and adjusting, by the master node, one or more parameters within the wireless network system.

In another embodiment, a computing system includes memory and at least one processor. The memory stores computer program instructions for operating and maintaining a wireless network system, which includes a 5G network and a Wi-Fi network, and the at least one processor is configured to execute the computer program instructions. The computer program instructions are configured to cause the at least one processor to execute capturing, by a master node, location data and measurement data reported by one or more mobile devices. The computer program instructions are further configured to cause the at least one processor to execute using, by the master node, the location data and the measurement data reported by the one or more mobile devices and measurement data captured by the master node to optimize network performance, and adjusting, by the master node, one or more parameters within the wireless network system.

In yet another embodiment, one or more non-transitory computer-readable mediums storing one or more computer programs for operating and maintaining a wireless network system comprising a 5G network and a Wi-Fi network is provided. The one or more computer programs is configured to cause at least one processor to execute capturing, by a master node, location data and measurement data reported by one or more mobile devices. The one or more computer programs is further configured to cause at least one processor to execute using, by the master node, the location data and the measurement data reported by the one or more mobile devices and measurement data captured by the master node to optimize network performance, and adjusting, by the master node, one or more parameters within the wireless network system.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a wireless communication system configured to operate both a 5G network and a wireless (Wi-Fi) network, according to an embodiment of the present invention.

FIG. 2 are images illustrating a heat map for trade-offs for single AP vs. two APs and singe frequency vs. dual frequencies, according to an embodiment of the present invention.

FIG. 3 are images illustrating a heat map for trade-offs for narrow beam pattern vs. wide beam pattern, according to an embodiment of the present invention.

FIG. 4 are images illustrating a heat map for the coverage impact by the transmit power settings, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention generally pertain to the installation and operation of a wireless communications system configured to operate both as a 5G network and a Wi-Fi network.

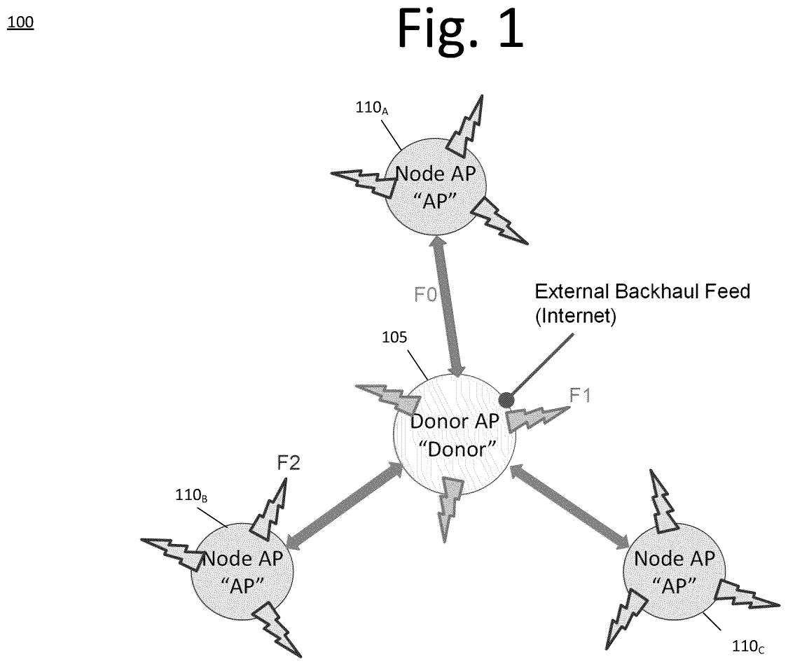

FIG. 1 is a diagram illustrating a wireless communication system 100 configured to operate both a 5G network and a wireless (Wi-Fi) network, according to an embodiment of the present invention. In some embodiments, system 100 includes a master (or donor) access point (AP) 105 that supports both 5G and Wi-Fi communications. Frequency F0 represents the communication between node APs 110_{A}, 110_{B}, and 110_{C}, which are configured to extend coverage throughout a building or venue, and master AP 105. Master AP 105 is connected through another 5G link, e.g., master AP 105 5G NR access frequency is on a midband (e.g., 3.5 GHz). See frequency F1 in FIG. 1. Each node AP 110_{A}, 110_{B}, and 110_{C} has a 5G NR access frequency on midband. See frequency F2 in FIG. 1.

Some embodiments of the present invention brings the most benefit to wireless network deployment in so far that multiple portable access points (APs) are enabled and deployed. The portability of the APs implies wireless connections among APs. See, for example, FIG. 1. In some embodiments, system 100 shown in FIG. 1 may be deployed on any wireless technology and is not limited to 5G, Wi-Fi, or 4G/LTE networks.

The initial deployment/installation of APs 105 assumes uniform user equipment (UEs) in the coverage area. System 100 uses coverage simulations involving prediction tools. The prediction tool in some embodiments is a computer simulation tool, i.e., SW. In one example, a typical input may include AP transmission (Tx) power, antenna beam pattern, location of the APs, building structure and the radio characteristics of the materials. In the same example, a typical output may include a RSRP/SINR distributions (heat map). In one embodiment, the cell capacity (i.e., throughput) can be inferred. Simulations are based on assumptions, prediction measurements rather than actual measurements, and the actual traffic pattern does not follow uniform distribution; under actual implementation, the coverage area may vary.

In some embodiments, system 100 (i.e., a self-organizing network) uses the measurement data after initial installation. The data includes the measurement data reported by UEs (or mobile devices) and the measurements captured by base stations (or APs) 105. UE measurements characterize the downlink (AP to UE) and AP 105 measurements characterize the uplink (UE to AP). These include RSRP (Reference Signal Received Power), RSRQ (Reference Signal Received Quality), SINR (Signal to Interference plus Noise Quality), throughput (data rate), call (voice/data) drops, handover failures, RACH (Random Access Channel) failures, etc. In addition, the location information of the UEs is particularly useful. This is particularly useful, if for example the AP has the beamforming/steering capability or the coordinated scheduling capability among APs.

The measurement data in some embodiments reveals the reality of the deployed network-distribution of UEs, throughput distributions, service/signal quality (SINR, RSRQ, RSRP, call failures, etc.) distributions. This data may be used to optimize the network performance. For example, cell capacity (i.e., throughput) is a typical performance criterion. The cell capacity has a direct relationship with SINR distribution. Hence, SINR improvement activity is used because of the measurements data available. The potential actions below are the steps, and do not have to be in sequence. Following are potential actions that can be taken:
ADJUSTMENT OF APs 105 POWERS. By adjusting the power for each AP 105, the interferences among APs 105 is reduced. For example, when multiple APs 110_{A}, 110_{B}, or 110_{C} are involved and the same frequency (e.g., frequency re-use of 1) is used among each AP 110_{A}, 110_{B}, or 110_{C}, interference issue at the boundaries of cell (i.e., overlapping areas covered by the beams from the multiple APs 110_{A}, 110_{B}, or 110_{C}) is experienced. In this example, the signal-to-interference-plus noise ratio (SINR) may fall below 0. This reduction below 0 causes a small throughput. For this reason, the overlapping area should be reduced. In one embodiment, the overlapping area is eliminated by allocating different frequencies among APs 110_{A}, 110_{B}, and 110_{C}. In this example, however, bandwidth (BW) may be insufficient. Conceptually, the overlapping areas are reduced by reducing the transmission (Tx) power of APs 110_{A}, 110_{B}, or 110_{C}. However, the reduction of the AP power results in a decrease of the coverage of the cell. Hence, this delicate tradeoff may need to go through some iterations.
ADJUSTMENT OF APS 110_{A}, 110_{B}, and 110_{C} LOCATIONS. Since APs 110_{A}, 110_{B}, and 110_{C} are portable, the location for each AP 110_{A}, 110_{B}, and 110_{C} may be changed. This change in location reduces the interferences and enhances the coverage. Similar to the concept as above, the overlapping area is reduced by separating APs 110_{A}, 110_{B}, or 110_{C} further away to improve SINR over the areas of interference. It should be noted however that this may create a situation where excessive power is radiated toward the walls creating reflections towards the interior of the building.
BEAMFORMING/STEERING. This include embodiments where donor AP 105 supports an advanced feature, e.g., the beam is directed toward the UEs, reducing the signal or signal-to-noise interference and increasing the frequency throughput. In this embodiment, the direction of where the beam is directed may be based on the location of the UEs. For example, when donor AP 105 uses a beamforming algorithm, donor AP 105 knows which beam to use since the UE may select the best beam and inform donor AP 105 of the best beam. In this example, the UE provides its location information to donor AP 105. By providing its location information, the UE also provides the best beam information to donor AP 105. In a further embodiment, AP(s) 110_{A}, 110_{B}, or 110_{C} can use advanced algorithms such as triangulation to determine the direction to the UE.
COORDINATED SCHEDULING AMONG APs 110_{A}, 110_{B}, OR 110_{C}. Instead of having each AP 110_{A}, 110_{B}, or 110_{C} work individually and independently with respect to each other, APs 110_{A}, 110_{B}, or 110_{C} work together, in some embodiments. For instance, the UEs (each belonging to different APs 110_{A}, 110_{B}, or 110_{C}) are scheduled at different time slices to significantly reduce interference in coverage. In this case, a (radio) link (e.g., X1 link) between APs 110_{A}, 110_{B}, or 110_{C} exchanges the control information and scheduling information for coordination purposes. Also, in this embodiment, APs 110_{A}, 110_{B}, or 110_{C} are synchronized. Normally, APs 110_{A}, 110_{B}, or 110_{C} perform their own scheduling independently. In this example, however, an agent or an algorithm coordinating APs 110_{A}, 110_{B}, or 110_{C} for scheduling is used. The algorithm may communicate with APs 110_{A}, 110_{B}, or 110_{C} (e.g., X1 link can be used for this purpose). Control information may include setting up the bearers, setting up the QoS, load balancing, and scheduling information may include real time allocation of resources among UEs to meet certain performance criteria.

There are multiple criteria to determine where to move the AP 110_{A}, 110_{B}, or 110_{C}. One criterion would be when the heat map created with the actual measurements or the actual performance is considerably different from the initial prediction/simulation. The measurement data may be used as calibration data for the prediction/simulation tool. Through a few iterations, better locations for better performance may be found.

### Create X1 Link Between Donor and AP

X1 link is defined in 3GPP standards, a link for communication between gNBs (i.e., APs). This link is utilized, or any communication link between APs may be utilized.

### Synchronizing Donor and AP

Synchronization in this embodiment synchronizes frame timing between APs 110_{A}, 110_{B}, or 110_{C}. Donor AP 105 may serve as a mater in this context. Slave AP's 110_{A}, 110_{B}, or 110_{C} frame time should be aligned to the Master's (Donor AP 105). In an embodiment, donor AP 105 creates the frame timing information (or the clock ticks). This clock is transferred to slave AP 110_{A}, 110_{B}, or 110_{C} through the communication link between them. Slave AP 110_{A}, 110_{B}, or 110_{C} may use this clock to synchronize its own frame timing.

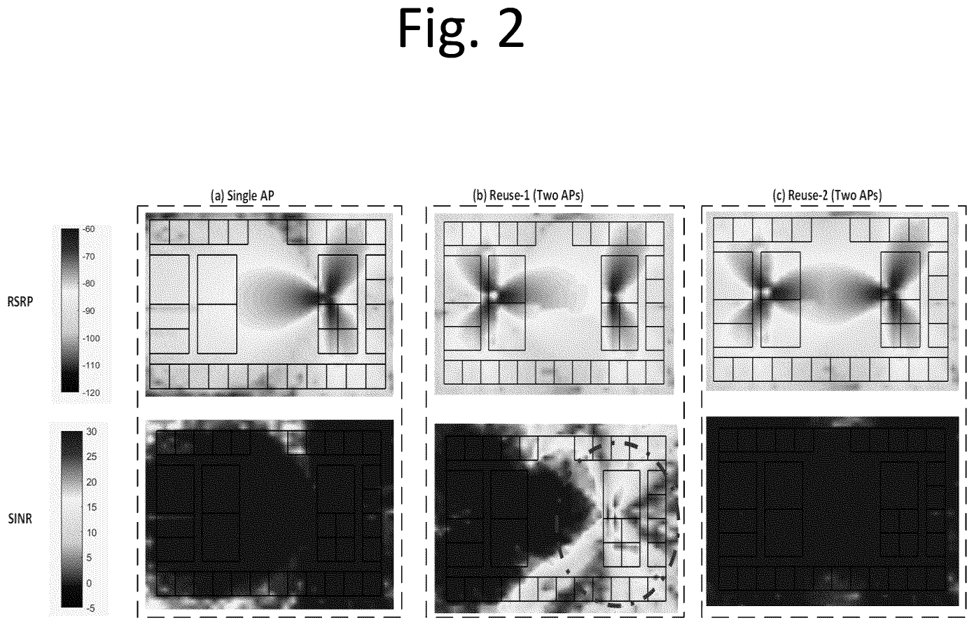

FIG. 2 are images illustrating a heat map for trade-offs for single AP vs. two APs and singe frequency vs. dual frequencies, according to an embodiment of the present invention.

Heat map for RSRP and SINR are considered as 1st order figure of merit since it can easily identify the coverage holes. The information can be used to derive the cell capacity or throughput. FIG. 2 shows three different configurations as an illustration. FIG. 2 (a) is an attempt to cover the venue with a single AP, creating reasonable coverage. FIG. 2 (b) is an attempt to enhance by throwing in another AP. This may enhance the RSRP. However, since both APs use the same frequency, SINR (dotted circle) is not sufficient. FIG. 2 (c) is to avoid the interference issue by using two different frequencies. This achieves the best SINR (uniform across the coverage area); however, this is accomplished at the expense of additional spectrum.

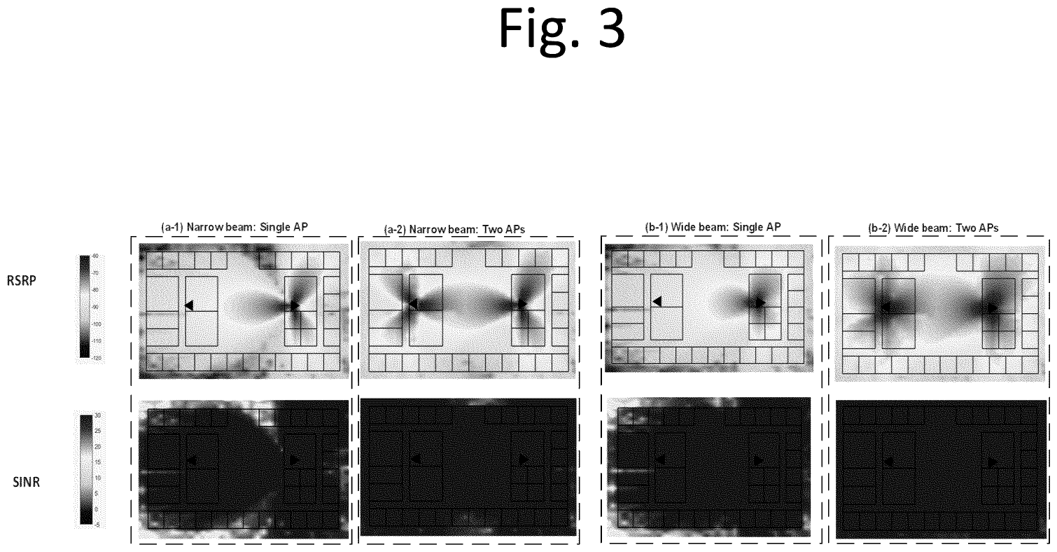

FIG. 3 are images illustrating a heat map for trade-offs for narrow beam pattern vs. wide beam pattern, according to an embodiment of the present invention.

FIG. 3 illustrates the antenna beam pattern (narrow (a) vs. wide (b)) of the AP on the performance. In this case, wide-beam antenna system provides the better performance (b-2) and b-1 shows better performance than a-1 with respect to a single AP configuration scenario).

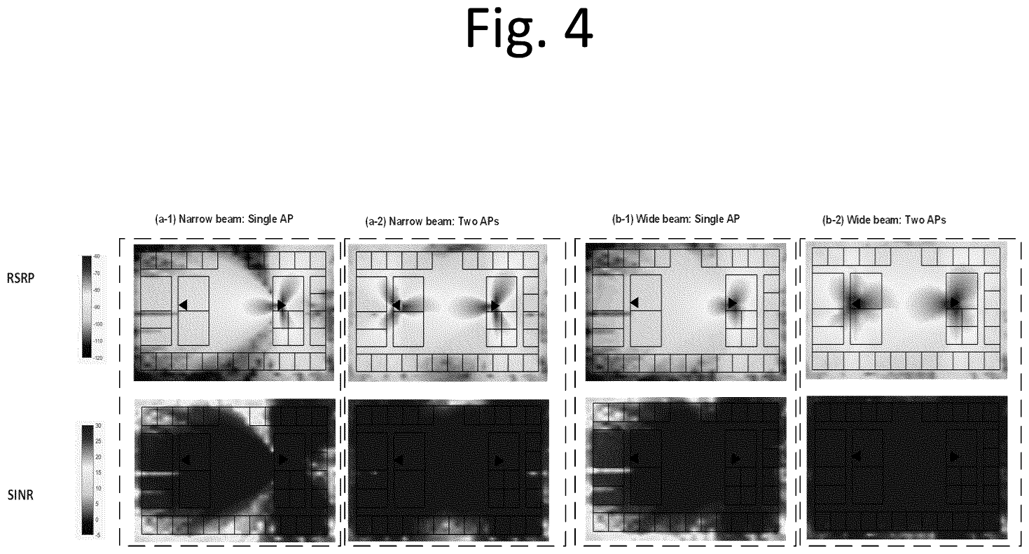

FIG. 4 are images illustrating a heat map for the coverage impact by the transmit power settings, according to an embodiment of the present invention.

It should be noted that FIG. 4 has the same configuration as FIG. 3, but the transmit power of the APs is reduced by 5 dB. Two AP configuration provides almost the same performance as the case where AP power is 5 dB higher.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for operating and maintaining a wireless network system comprising a 5G network and a Wi-Fi network, comprising:
capturing, by a master node, location data and measurement data reported by one or more mobile devices;
using, by the master node, the location data and the measurement data reported by the one or more mobile devices and measurement data captured by the master node to optimize network performance; and
adjusting, by the master node, one or more parameters within the wireless network system.

2. The computer-implemented method of claim 1, wherein the measurement data comprises mobile device distribution, service quality and signal quality, all of which is captured by the one or more mobile devices.

3. The computer-implemented method of claim 1, wherein the adjusting of the wireless network system comprises
allocating a different frequency to each of a plurality of access nodes, or reducing a transmission power of each of the plurality of access nodes, to reduce an overlap coverage area between each of the plurality of access nodes.

4. The computer-implemented method of claim 1, wherein the adjusting of the wireless network system comprises
adjusting a location of each of the plurality of access nodes to reduce interference and enhance coverage of each of the plurality of access nodes.

5. The computer-implemented method of claim 1, wherein the adjusting of the wireless network system comprises
utilizing beamforming or steering, by the master node, to direct the beam towards each of the plurality of mobile devices, reducing the signal or signal-to-noise interference and increasing the frequency throughput.

6. The computer-implemented method of claim 5, wherein the utilizing of the beam comprises
directing the beam in a direction where each of the plurality of mobile devices are located.

7. The computer-implemented method of claim 1, wherein the adjusting of the wireless network system comprises
scheduling each of the plurality of mobile devices in different time slices to reduce interference significantly, wherein each of the plurality of mobile devices belong to different access nodes.

8. The computer-implemented method of claim 7, wherein the scheduling of each of the plurality of devices comprises
exchanging, on a radio link, control information and scheduling information between each of the plurality of access points for coordination purposes.

9. A computing system, comprising:
memory storing computer program instructions for operating and maintaining a wireless network system comprising a 5G network and a Wi-Fi network; and
at least one processor configured to execute the computer program instructions, wherein the computer program instructions are configured to cause the at least one processor to execute:
capturing, by a master node, location data and measurement data reported by one or more mobile devices;
using, by the master node, the location data and the measurement data reported by the one or more mobile devices and measurement data captured by the master node to optimize network performance; and
adjusting, by the master node, one or more parameters within the wireless network system.

10. The computer-implemented method of claim 9, wherein the measurement data comprises mobile device distribution, service quality and signal quality, all of which is captured by the one or more mobile devices.

11. The computer-implemented method of claim 9, wherein the computer program instructions are further configured to cause the at least one processor to execute:
allocating a different frequency to each of a plurality of access nodes, or reducing a transmission power of each of the plurality of access nodes, to reduce an overlap coverage area between each of the plurality of access nodes.

12. The computer-implemented method of claim 9, wherein the computer program instructions are further configured to cause the at least one processor to execute:
adjusting a location of each of the plurality of access nodes to reduce interference and enhance coverage of each of the plurality of access nodes.

13. The computer-implemented method of claim 9, wherein the computer program instructions are further configured to cause the at least one processor to execute:
utilizing beamforming or steering, by the master node, to direct the beam towards each of the plurality of mobile devices, reducing the signal or signal-to-noise interference and increasing the frequency throughput.

14. The computer-implemented method of claim 13, wherein the computer program instructions are further configured to cause the at least one processor to execute:
directing the beam in a direction where each of the plurality of mobile devices are located.

15. The computer-implemented method of claim 9, wherein the computer program instructions are further configured to cause the at least one processor to execute:
scheduling each of the plurality of mobile devices in different time slices to reduce interference significantly, wherein each of the plurality of mobile devices belong to different access nodes.

16. The computer-implemented method of claim 15, wherein the computer program instructions are further configured to cause the at least one processor to execute:
exchanging, on a radio link, control information and scheduling information between each of the plurality of access points for coordination purposes.

17. One or more non-transitory computer-readable mediums storing one or more computer programs for operating and maintaining a wireless network system comprising a 5G network and a Wi-Fi network, the one or more computer programs configured to cause at least one processor to execute:
capturing, by a master node, location data and measurement data reported by one or more mobile devices;
using, by the master node, the location data and the measurement data reported by the one or more mobile devices and measurement data captured by the master node to optimize network performance; and
adjusting, by the master node, one or more parameters within the wireless network system.

18. The one or more non-transitory computer-readable mediums of claim 17, wherein the one or more computer programs are further configured to cause at least one processor to execute:
utilizing beamforming or steering, by the master node, to direct the beam towards each of the plurality of mobile devices, reducing the signal or signal-to-noise interference and increasing the frequency throughput; and
directing the beam in a direction where each of the plurality of mobile devices are located.

19. The computer-implemented method of claim 17, wherein the one or more computer programs are further configured to cause at least one processor to execute:
scheduling each of the plurality of mobile devices in different time slices to reduce interference significantly, wherein each of the plurality of mobile devices belong to different access nodes.

20. The computer-implemented method of claim 19, wherein the one or more computer programs are further configured to cause at least one processor to execute:
exchanging, on a radio link, control information and scheduling information between each of the plurality of access points for coordination purposes.
